(19) United States
(12) Patent Application Publication
(10) Pub. No.: US 2026/0149739 A1
(43) Pub. Date: May 28, 2026

(54) CYBER DECEPTION AUTOMATION PROCESS

(71) Applicant: LegioX Cyber Technologies, Inc., Baltimore, MD (US)

(72) Inventor: Gordon Long, Baltimore, MD (US)

(21) Appl. No.: 19/402,946

(22) Filed: Nov. 26, 2025

Related U.S. Application Data
(60) Provisional application No. 63/726,222, filed on Nov. 27, 2024.

(51) Int. Cl. H04L 9/40

(52) U.S. Cl. CPC H04L 63/1491

(57) ABSTRACT

A method, system, and medium for hiding security software on a computing system to limit or prevent cyber attackers and similar malicious actors from identifying, disabling, or otherwise avoiding security software. Embodiments include security software hiding techniques that change the file location of the security software, interrupt the initial phases of an attack, and flag attempts at circumventing the hiding techniques.

### CROSS-REFERENCE TO RELATED APPLICATIONS

This application claims the benefit of and priority to U.S. Provisional Patent Application No. 63/726,222, filed Nov. 27, 2024, which is hereby incorporated by reference herein in its entirety.

### TECHNICAL FIELD

The present disclosure is directed to the secure operation of computer systems, and more particularly, monitoring for and defending against cyber security attacks.

### BACKGROUND

Computer systems are capable of detecting and displaying a list of currently running applications. Computer systems can achieve this by monitoring system processes and utilizing operating system features to track active applications and their resource usage. This information is often presented in task management tools that provide a user interface to view and manage these processes. Monitoring running applications can be used to help optimize system performance and diagnose issues. These monitoring capabilities can help enable efficient resource allocation and support troubleshooting efforts. Cyber attackers who identify running applications on a computer system can attempt to disable, bypass, or avoid security software to avoid detection and carry out cyberattacks. Cybersecurity applications can monitor for malicious attempts by cyber attackers to disable or bypass security software on a computer system.

### SUMMARY

The present disclosure relates to methods, systems, and mediums for hiding security software on a computing system. According to various, but not necessarily all, embodiments of the present disclosure there is provided a method for hiding security software on a computing system comprising: automatically detecting what computer programs are running on the computing system; automatically identifying one or more of the user activity, service activity, and computer program activity on the computing system; automatically evaluating and executing hiding techniques to hide the security software on the computing system; and automatically monitoring the hiding techniques.

According to various, but not necessarily all, embodiments of the present disclosure there is provided a system for hiding security software on a computing system comprising: a memory storing executable instructions; and a processor configured to execute the instructions to: automatically detect what computer programs are running on the computing system; automatically identify one or more of the user activity, service activity, and computer program activity on the computing system; automatically evaluate and execute hiding techniques to hide the security software on the computing system; and automatically monitor the hiding techniques.

According to various, but not necessarily all, embodiments of the present disclosure there is provided a non-transitory computer readable medium, having a computer program stored thereon that, when run on a processor, enables the processor to cause a device to: automatically detect what computer programs are running on a computing system; automatically identify one or more of the user activity, service activity, and computer program activity on the computing system; automatically evaluate and execute hiding techniques to hide the security software on the computing system; and automatically monitor the hiding techniques.

According to various, but not necessarily all, embodiments of the present disclosure, the hiding techniques include one or more of (1) changing one or more of (a) a file system location of the security software, (b) a file name of the security software, (c) a service name of the security software, (d) a service description of the security software, or (e) file metadata of the security software, (2) interrupting the initial reconnaissance phase or process discovery phase of an attack chain to disguise from a cyber attacker that the hiding techniques are protecting the computing system, (3) automatically determining where to place honeyfiles so that the honey files blend in with the computing system in a way that prevents detection by cyber attackers, (4) automatically implementing efforts to aid in deception and provide information as needed to those executing the hiding techniques, and (5) adjustments based on an operating system of the computing system, wherein the adjustments account for one or more of a type of process or service running on the operating system, formatting file paths according to the operating system, and determining file locations to be monitored based on the operating system.

According to various, but not necessarily all, embodiments of the present disclosure, the security software identifies activity by cyber attackers attempting to circumvent the hiding techniques.

### BRIEF DESCRIPTION OF DRAWINGS

The skilled artisan will understand that the drawings are primarily for illustrative purposes and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar or structurally similar elements).

The foregoing and other features and advantages provided by the present disclosure will be more fully understood from the following description of exemplary embodiments when read together with the accompanying drawings, in which:

FIG. 1 depicts an example computing device appropriate for use with embodiments of the present disclosure.

FIG. 2 depicts an example flow diagram of a method for hiding security software on a computing device, as carried out by embodiments of the present disclosure.

FIG. 3 depicts an example flow diagram of a process for ingesting data, as carried out by systems and methods of the present disclosure.

FIG. 4 depicts an example flow diagram of a process for determining deceptive service and file names, service descriptions, file metadata, and file system locations as carried out by systems and methods of the present disclosure.

FIG. 5 depicts a schematic illustration of an exemplary network, in accordance with at least some exemplary embodiments of the present disclosure; and

FIG. 6 depicts a schematic illustration of an exemplary network, in accordance with at least some exemplary embodiments of the present disclosure.

### DETAILED DESCRIPTION

In general, the subject technology provides an automated approach to hide security software from cyber attackers. Cyber attackers often seek to identify applications running on a target computing system to understand its environment and security defenses. Once identified, cyber attackers may attempt to disable, avoid, or bypass security software on a computing system and/or exploit vulnerabilities in the security software. By disabling, avoiding, or bypassing security software on a computing system, cyber attackers aim to evade detection and gain the freedom to execute their malicious activities. Malicious activities may include, but are not limited to, deploying malware, stealing data, or establishing permanent access to certain applications. Cyber attackers utilize methods including process discovery and looking for running security applications to disable, bypass, or avoid such security measures. Once cyber attackers notice and identify security products, they can figure out how to avoid such security applications or take steps at evasion. Additionally, cyber attackers may engage in reconnaissance techniques, such as querying a computer system's APIs to gather information about the target system, network, or organization to identify potential vulnerabilities. Moreover, cyber attackers may engage in phishing activities by sending deceptive emails or messages to deceive users into revealing sensitive information or installing malicious software. Former approaches to cyber deception and security have utilized techniques such as monitoring tokens, files, or servers/computers (e.g. honeypots) to detect malicious activity, rather than focusing on the actual hiding of the security product itself.

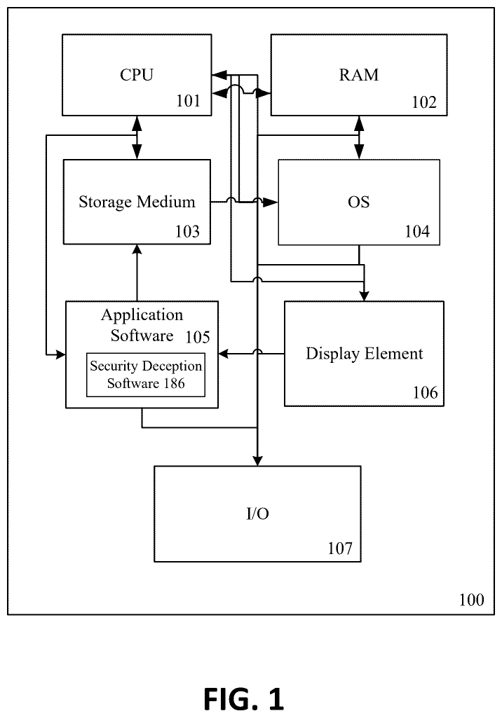

Systems and methods are described herein for security software that automatically hides itself (e.g. security deception software 186 as depicted in FIG. 1). In one or more embodiments, the systems and methods taught herein include the security deception software 186 determining how to best hide itself by changing its file system location, name, service name, or service description to blend in normally on a computing device to prevent detection. In some embodiments, the security deception software 186 determines where to place decoy files or honeyfiles (e.g. files to be monitored) so that they blend in with an operating system in a way that makes detection difficult and ensures a higher likelihood of identifying suspicious activity on a computing device. In one or more embodiments, honeyfiles include files that are placed on a device to detect unauthorized access or identify intruders, malicious users, or insider threats. By monitoring any interactions occurring with honeyfiles, security tooling can identify suspicious behavior. In one or more embodiments, security deception software 186 automatically creates files to protect using a variety of file types or extensions. In one or more embodiments, security deception software 186 automatically places files in different locations on a file system depending on an initial determination from a process discovery, user interactions, etc. For example, depending on the services and users running on the host, artificial intelligence will select locations and files (e.g. particular configurations or keyfiles) that blend with the services running on the host system. In some examples, the services create users. By putting decoy files in areas on the host system that are assigned to a particular user, and therefore where that particular user's standard files would normally be located, the odds of catching a cyber attacker are increased. In some embodiments, security deception software 186 automates not only the generation of honeyfiles but also their placement in deceptive file system locations and/or with deceptive filenames and/or with deceptive metadata (e.g. last modified time, created time, etc). In some embodiments, security deception software 186 will utilize existing data on the device to generate the honeyfiles. The systems and methods taught herein are applicable to a wide range of security applications and software programs to protect against cyberattacks.

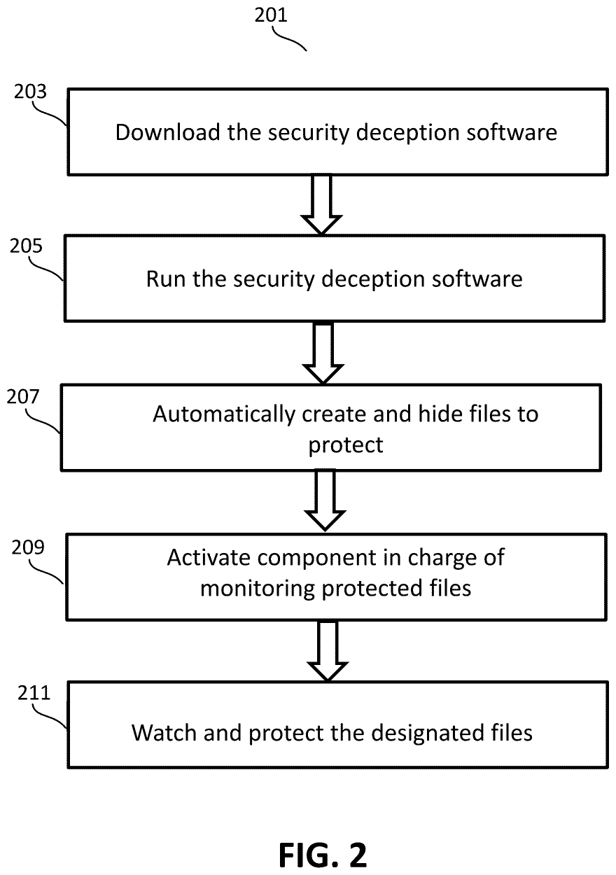

FIG. 1 depicts an example computing device appropriate for use with embodiments of the system of the present disclosure. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105 (including, but not limited to, security deception software 186), a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms. Various examples of such general-purpose multi-unit computer networks suitable for embodiments of the disclosure, their typical configuration and many standardized communication links are well known to one skilled in the art. In some embodiments, the CPU 101 performs the operations described with respect to FIGS. 2 to 4.

In one or more embodiments, security deception software 186 can be placed on a device or computer and automatically detect what is currently running on that device or computer. In some embodiments, security deception software 186 automatically determines or identifies on the computing system at least one of user activity, service activity, and computer program activity. User activity generally comprises what users are currently looking at or doing on the computing system, including how users are interacting with file and services. Service activity includes configurations and setups for longer running services on a system, including for user, management, security, or other software. Computer program activity generally includes software running on the device. In one or more embodiments, security deception software 186 automatically determines how to best hide its own program by changing its file system location, name, service name, service description, etc. to blend in normally on a computing device to prevent detection. A service can include any method of continuously running a software on any operating system and is not strictly a Windows service. In one or more embodiments, security deception software 186 automatically determines where to place honeyfiles, or files to be monitored, so that they blend in with an operating system in a way that makes detection more difficult, ensuring a higher likelihood of catching suspicious activity on said device or computer. In some embodiments, security deception software 186 automatically implements efforts to aid in deception and provides information as needed to those running the program so that they are aware of where security deception software 186 resides. In some embodiments, security deception software 186 finds different places to hide depending on the computer it is placed. For example, if security deception software 186 is placed on 10,000 different computers it can appear in 10,000 different ways. It can also appear differently even on the same device if it is removed and then re-deployed.

In one or more embodiments, security deception software 186 automates deceptive techniques for the defender and makes discoveries by cyber attackers more difficult. In some embodiments, security deception software 186 inhibits an attacker from normal process, service, or file system discovery. In one or more embodiments, security deception software 186 blends into an operating system so cyber attackers do not immediately know that security deception software 186 is running on a protected machine and thus are less able to take action to disable or circumvent security deception software 186. In one or more embodiments, security deception software 186 interrupts the initial reconnaissance or process discovery phase of an attack chain to disguise the use of the hiding techniques such that cyber attackers will not immediately know that security deception software 186 is protecting a target computing device. In some embodiments, hiding techniques may include altering the metadata and names of files to blend in with surrounding files and locations, services or processes already running on the system, and existing users. In some embodiments, hiding techniques may include mimicking existing services or processes to present a running service, or using what is expected to run on a device to hide processes, services, and files. In some embodiments, cyber attackers cannot detect security deception software 186 and will not take specific steps to avoid triggering security deception software 186. In one or more embodiments, security deception software 186 complements and enhances security or deception software focused on protecting potential targets including, but not limited to, servers, endpoints, or devices. In some embodiments, security deception software 186 includes the ability to automatically generate deceptive attributes or metadata of files (e.g. properties, code signatures, details such as size and modified time, etc.).

In one or more embodiments, security deception software 186 is automated by a binary that is executed on a computer's operating system and monitors for file system information, file interactions with users and services, or a list of normally running services. In some embodiments, the binary utilizes machine learning or artificial intelligence to determine what to call security deception software 186 when it is hidden. In some embodiments, the binary will install security deception software 186 in an appropriate location under a deceptive application name and run security deception software 186 under a deceptive service name. In some embodiments, the binary utilizes machine learning or artificial intelligence to determine the deceptive service description of the deceptive service name which runs security deception software 186. In some embodiments, the binary will either install, download, or generate default file types (e.g. PDF, database files, etc.) associated with security deception software 186 and utilize machine learning or artificial intelligence to place the files at certain locations, with certain names, and with certain metadata to best blend in with what the computer's operating system is doing. In some embodiments, the binary will provide a notification to an underlying user (e.g. administrator, network admin, etc.) about where the security deception software 186 and associated files are hidden on the computer's operating system.

FIG. 2 depicts an example flow diagram of a method for hiding security software (e.g. security deception software 186) on a computing device, as carried out by embodiments of the present disclosure. At block 203 of the method 201, security deception software 186 is downloaded on a computing device intended for protection. At block 205 of the method 201, security deception software 186 is run and takes time to execute as it performs process discovery and monitors user interactions with files and processes. In some embodiments, at block 205, the security deception software 186 may send the information collected during the process discovery and monitoring actions to a large language model (LLM) or artificial intelligence (AI) application that assists in determining how honeyfiles or RansomGuard should be hidden based on the collected information. At block 207 of the method 201, security deception software 186 automatically creates and hides files to protect (e.g., with a variety of file types or extensions) by utilizing deception techniques including, but not limited to, copying existing files and renaming or completely independently generating said files. At block 209 of the method 201, once security deception software 186 has finished creating the files, security deception software 186 will either download or activate a second component in charge of monitoring the protected files. This second component may either be an original software binary or a new binary. Before this second component is run and actively begins monitoring the protected files, it will be hidden on the target computer and components such as the binary name, file system location, service name, service description, and binary metadata may be changed. At block 211 of the method 201, the monitoring or second component of the software is activated to watch and protect the designated files. In some embodiments, information may or may not be transmitted to the user about where the files have been hidden and where the monitoring program has been hidden in terms of filename, file system location, service name, etc.

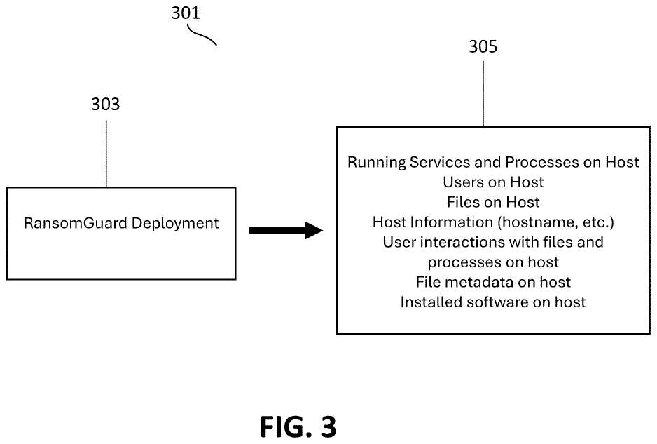

FIG. 3 depicts an example flow diagram of a method for ingesting data, as carried out by embodiments of the present disclosure. At block 303 of the method 301, security deception software 186 aggregates or consolidates data from various sources including, but not limited to, applications such as the RansomGuard Deployment. The RansomGuard Deployment may include, but is not limited to, executable binaries that may exist on different operating systems. RansomGuard Deployment also refers to software that receives or aggregates information from the device to be protected. The information received or aggregated from the protected device may include, but is not limited to, the operating system version, processes, services, files, and users. The information is utilized to deploy both the honeyfiles and RansomGuard, a software utilized to monitor the honeyfiles. RansomGuard Deployment may also use various methods to hide both the honeyfiles and RansomGuard including, but not limited to, changing file metadata, names, service names, to better blend the honeyfiles and RansomGuard into the protected device. As an illustrative example, on a protected device running mysql, RansomGuard Deployment would detect that as a process and may tailor files to match the mysql process, configuration, credentials, or some other characteristic related to mysql. In some embodiments, data is aggregated or consolidated from various sources. At block 305 of the method 301, security deception software 186 ingests relevant data, including but not limited to, running services and processes on host, users on host, files on host, host information (hostname, etc.), user interactions with files, or processes on host.

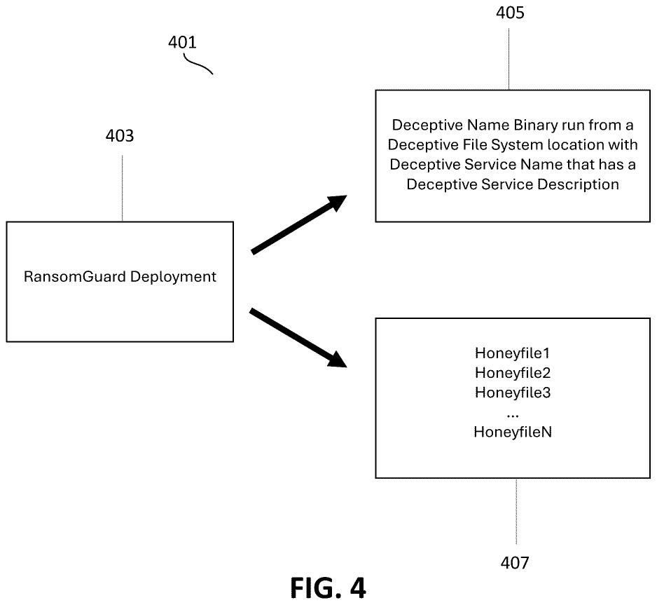

FIG. 4 depicts an example flow diagram of a method for determining deceptive service and file names, as well as deceptive service descriptions as carried out by embodiments of the present disclosure. At block 403 of the method 401, security deception software 186 aggregates or consolidates data from various sources including, but not limited to process information, running services, and existing users. In some embodiments, data is aggregated or consolidated from various sources, including RansomGuard Deployment. At block 405 of the method 401, security deception software 186 creates a deceptive name for a binary run with a deceptive service name and deceptive service description. In one or more embodiments, security deception software 186 makes decisions based on the information it has collected on what to name itself. In one or more embodiments, security deception software 186 makes decisions based on the information it has collected on what to name a running service. In one or more embodiments, security deception software 186 makes decisions based on the information it has collected on what description to attach to a running service. At block 407 of the method 401, security deception software 186 renames files with deceptive names. In one or more embodiments, security deception software 186 makes decisions based on the information it has collected on what to name files to guard. In some embodiments, security deception software 186 makes decisions based on the information it has collected on where to place files that are guarded on the file system. In some embodiments, security deception software 186 makes decisions based on the information it has collected on what metadata to modify for the files that are guarded on the file system.

According to an exemplary embodiment of the present disclosure, data may be transferred to the computing system, stored by the computing system and/or transferred by the computing system to users of the computing system across local area networks (LANs) (e.g., office networks, home networks) or wide area networks (WANs) (e.g., the Internet). In one or more embodiments, the computing system may be comprised of numerous servers communicatively connected across one or more LANs and/or WANs. One of ordinary skill in the art would appreciate that there are numerous manners in which the computing system could be configured and embodiments of the present disclosure are contemplated for use with any configuration.

In general, the systems and methods provided herein may be employed by a user of a computing device whether connected to a network or not. Similarly, some steps of the methods provided herein may be performed by components and modules of the computing system whether connected or not. While such components/modules are offline, and the data they generate will then be transmitted to the relevant other parts of the computing system once the offline component/module comes again online with the rest of the network (or a relevant part thereof). According to an embodiment of the present disclosure, some of the applications of the present disclosure may not be accessible when not connected to a network, however a user or a module/component of the computing system itself may be able to compose data offline from the remainder of the system that will be consumed by the system or its other components when the user/offline system component or module is later connected to the system network.

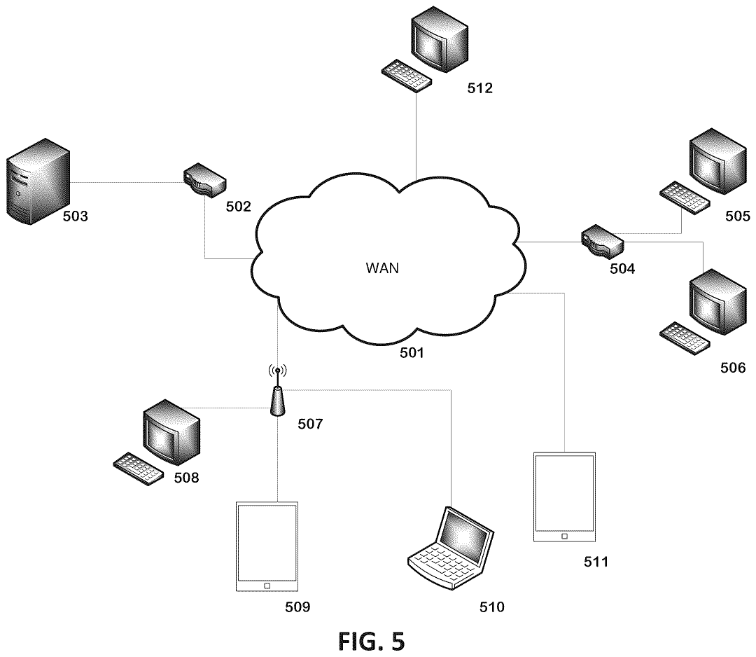

Referring to FIG. 5, a schematic overview of a system in accordance with an embodiment of the present disclosure is shown. The system is comprised of one or more application servers 503 for electronically storing information used by the system. The application server 503 may in some embodiments, be a device storing files that are being monitored for file integrity verification according to aspects of the subject technology as discussed above. Or in some embodiments, the server 503 may be a host computing device operating the subject technology remotely from computing devices 505 or 506 that have files being monitored for suspicious activity. Applications in the server 503 may retrieve and manipulate information in storage devices and exchange information through a WAN 501 (e.g., the Internet). Applications in server 503 may also be used to manipulate information stored remotely and process and analyze data stored remotely across a WAN 501 (e.g., the Internet). In some embodiments, a computing device 512 stores software in the form of a file integrity engine. The file integrity engine may include software instructions that monitor files in a filesystem stored in the application server 503 or stored on local computing devices 505, 506, 508, 509, 510, and 511.

The exchange of information through the WAN 501 or other network may occur through one or more high speed connections. In some cases, high speed connections may be over-the-air (OTA), passed through networked systems, directly connected to one or more WANs 501 or directed through one or more routers 502. Router(s) 502 are completely optional and other embodiments in accordance with the present disclosure may or may not utilize one or more routers 502. One of ordinary skill in the art would appreciate that there are numerous ways server 503 may connect to WAN 501 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 503 via WAN 501 or other network in numerous ways. For instance, a component or module may connect to the system i) through a computing device 512 directly connected to the WAN 501, ii) through a computing device 505, 506 connected to the WAN 501 through a routing device 504, iii) through a computing device 508, 509, 510 connected to a wireless access point 507 or iv) through a computing device 511 via a wireless connection (e.g., CDMA, GMS, 3G, 4G, 5G) to the WAN 501. One of ordinary skill in the art will appreciate that there are numerous ways that a component or module may connect to server 503 via WAN 501 or other network, and embodiments of the present disclosure are contemplated for use with any method for connecting to server 503 via WAN 501 or other network. Furthermore, server 503 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

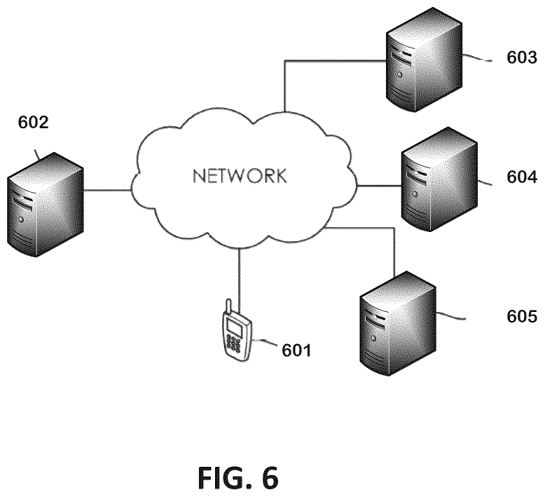

Turning now to FIG. 6, a continued schematic overview of a cloud-based system in accordance with an embodiment of the present invention is shown. In FIG. 6, the cloud-based system is shown as it may interact with users and other third party networks or APIs (e.g., APIs associated with the exemplary disclosed E-Ink displays). For instance, a user of a mobile device 601 may be able to connect to application server 602. Application server 602 may be able to enhance or otherwise provide additional services to the user by requesting and receiving information from one or more of an external content provider API/website or other third party system 603, a constituent data service 604, one or more additional data services 605 or any combination thereof. Additionally, application server 602 may be able to enhance or otherwise provide additional services to an external content provider API/website or other third party system 603, a constituent data service 604, one or more additional data services 605 by providing information to those entities that is stored on a database that is connected to the application server 602. One of ordinary skill in the art would appreciate how accessing one or more third-party systems could augment the ability of the system described herein, and embodiments of the present invention are contemplated for use with any third-party system.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

In at least some exemplary embodiments, the exemplary disclosed system may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. For example, machine learning or artificial intelligence modules may be configured to automatically identify optimal file size thresholds for invoking hashing according to the above methodologies, automatically identify modified or deleted files in the filesystem, and determine scenarios for system shutdown to protect the filesystem(s). The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. A computer-implemented method for hiding security software on a computing system, comprising:
automatically detecting computer programs running on the computing system;
automatically identifying one or more of user activity, service activity, and computer program activity on the computing system;
automatically evaluating and executing hiding techniques to hide the security software on the computing system; and
automatically monitoring the hiding techniques.

2. The method of claim 1, wherein the hiding techniques include changing a file system location of the security software, a file name of the security software, a service name of the security software, a service description of the security software, or file metadata of the security software.

3. The method of claim 1, wherein the hiding techniques include interrupting an initial reconnaissance phase or process discovery phase of an attack chain to disguise from a cyber attacker that the hiding techniques are protecting the computing system.

4. The method of claim 1, wherein the hiding techniques include automatically determining where to place honeyfiles so that the honey files blend in with the computing system in a way that prevents detection by cyber attackers.

5. The method of claim 1, wherein the hiding techniques include automatically implementing efforts to aid in deception and provide information as needed to those executing the hiding techniques.

6. The method of claim 1, wherein the hiding techniques include adjustments based on an operating system of the computing system, wherein the adjustments account for one or more of a type of process or service running on the operating system, formatting file paths according to the operating system, and determining file locations to be monitored based on the operating system.

7. The method of claim 1, wherein the security software identifies activity by cyber attackers attempting to circumvent the hiding techniques.

8. A system for hiding security software on a computing system, comprising:
a memory storing executable instructions; and
a processor configured to execute the instructions to:
automatically detect computer programs running on the computing system;
automatically identify one or more of user activity, service activity, and computer program activity on the computing system;
automatically evaluate and execute hiding techniques to hide the security software on the computing system; and
automatically monitor the hiding techniques.

9. The system of claim 8, wherein the hiding techniques include changing a file system location of the security software, a file name of the security software, a service name of the security software, a service description of the security software, or file metadata of the security software.

10. The system of claim 8, wherein the hiding techniques include interrupting an initial reconnaissance phase or process discovery phase of an attack chain to disguise from a cyber attacker that the hiding techniques are protecting the computing system.

11. The system of claim 8, wherein the hiding techniques include automatically determining where to place honeyfiles so that the honey files blend in with the computing system in a way that prevents detection by cyber attackers.

12. The system of claim 8, wherein the hiding techniques include automatically implementing efforts to aid in deception and provide information as needed to those executing the hiding techniques.

13. The system of claim 8, wherein the hiding techniques include adjustments based on an operating system of the computing system, wherein the adjustments account for one or more of a type of process or service running on the operating system, formatting file paths according to the operating system, and determining file locations to be monitored based on the operating system.

14. The system of claim 8, wherein the security software can identifies activity by cyber attackers attempting to circumvent the hiding techniques.

15. A non-transitory computer readable medium, having a computer program stored thereon that, when run on a processor, enables the processor to cause a device to:
automatically detect computer programs running on a computing system;
automatically identify one or more of user activity, service activity, and computer program activity on the computing system;
automatically evaluate and execute hiding techniques to hide the security software on the computing system; and
automatically monitor the hiding techniques.

16. The non-transitory computer readable medium of claim 15, wherein the hiding techniques include changing a file system location of the security software, a file name of the security software, a service names of the security software, a service description of the security software, or file metadata of the security software.

17. The non-transitory computer readable medium of claim 15, wherein the hiding techniques include interrupting an initial reconnaissance phase or process discovery phase of an attack chain to disguise from a cyber attacker that the hiding techniques are protecting the computing system.

18. The non-transitory computer readable medium of claim 15, wherein the hiding techniques automatically determining where to place honeyfiles so that the honeyfiles blend in with the computing system in a way that prevents detection by cyber attackers.

19. The non-transitory computer readable medium of claim 15, wherein the hiding techniques include automatically implementing efforts to aid in deception and provide information as needed to those executing the hiding techniques.

20. The non-transitory computer readable medium of claim 15, wherein the hiding techniques include adjustments based on an operating system of the computing system, wherein the adjustments account for one or more of a type of process or service running on the operating system, formatting file paths according to the operating system, and determining file locations to be monitored based on the operating system.

21. The non-transitory computer readable medium of claim 15, wherein the security software identifies activity by cyber attackers attempting to circumvent the hiding techniques.
